(19) United States
(12) Patent Application Publication
(10) Pub. No.: US 2009/0238978 A1
(43) Pub. Date: Sep. 24, 2009

(54) METHOD OF CREATING A STITCHED IMAGE RESEMBLING EMBROIDERY

(76) Inventors: Robert Marino, Louisville, KY (US); Daniel L. Dilamarter, Louisville, KY (US)

Correspondence Address: PILLSBURY WINTHROP SHAW PITTMAN LLP, P.O. BOX 10500, MCLEAN, VA, 22102, US

(21) Appl. No.: 12/177,072

(22) Filed: Jul. 21, 2008

Related U.S. Application Data
(60) Provisional application No. 61/038,645, filed on Mar. 21, 2008.

(51) Int. Cl. B05D 5/00

(52) U.S. Cl. 427/261; 427/288

(57) ABSTRACT

A method for applying an image to a pre-stitched surface to resemble embroidery creates a pre-stitched surface by covering a piece of fabric with stitching of white, neutral-colored, or transparent thread. The pre-stitched surface uses patterns of stitching that are random or abstract in alignment and shape. A digital image is applied onto the pre-stitched surface through dye sublimation or printing, and resembles traditional embroidery. The image may be computer manipulated to appear as if it is traditional stitched embroidery.

### CROSS-REFERENCE TO RELATED APPLICATION

This application claims the benefit of U.S. Provisional Patent Application Ser. No. 61/038,645 filed Mar. 21, 2008.

### FIELD OF THE INVENTION

The present invention relates generally to methods of stitching a design onto a piece of fabric or other surface, and more particularly to a method of applying digital images onto a pre-stitched surface that has been covered with randomized patterns stitched with white, neutral-colored, or transparent thread.

### BACKGROUND

Embroidered designs on clothing and other objects are highly prized, as such embroidery traditionally was created by handwork. Machine embroidery (either semi-automated with humans using sewing machines, or fully automated with machine-controlled sewing) is now widely used, but still is relatively costly in time and materials. Moreover, fully-automated machine-controlled embroidery is only profitable when a large number of the embroidered objects arc produced, thereby justifying the cost of machine set-up for a particular embroidery design.

### SUMMARY OF THE INVENTION

The present invention is a method for applying an image to a pre-stitched surface. The pre-stitched surface is created by covering a piece of fabric with stitching of white, neutral-colored, or transparent thread. The pre-stitched surface uses patterns of stitching that are random or abstract in alignment and shape. A digital image is then applied onto the pre-stitched surface through dye sublimation or printing, and resembles a design using traditional embroidery. The image may be a computer manipulated digital image that is modified to appear as if it is traditional stitched embroidery. This method is particularly suitable for creation of individual pieces or small lots of an embroidery design, as standard pre-stitched pieces can be used with digitized images that are individually created.

### IN THE DRAWING

FIG. 1 shows a white-colored pre-stitched surface stitched with randomized patterns;

FIG. 2 shows a digital image applied onto the pre-stitched surface; and

FIGS. 3-5 illustrate application of a pre-stitched surface to an article of clothing, followed by application of an image into the pre-stitched surface.

### DETAILED DESCRIPTION OF THE PREFERRED EMBODIMENTS

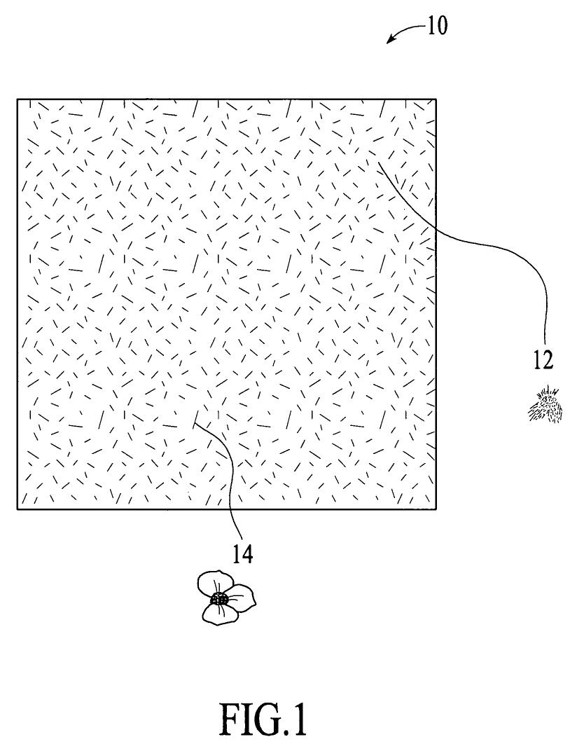

FIG. 1 shows a pre-stitched surface with randomized patterns 10. The surface fabric is covered with stitched patterns that use white, neutral-colored, or transparent thread and that are random or abstract in both alignment 12 and shape 14. In other words, the patterns are not ordered in an easily recognizable ordered geometric pattern (e.g. lines, circles, squares, spirals, etc.) or in recognizable particular shapes (e.g. dogs, cats, landscapes, faces, letters, numbers, etc.). The thread color chosen for illustration is white, but the present invention includes stitched surfaces of any neutral-colored or transparent thread that are compatible with receiving a wide range of colored sublimation dye or printing, and accurately depicting a digital image applied with sublimation dye or printing.

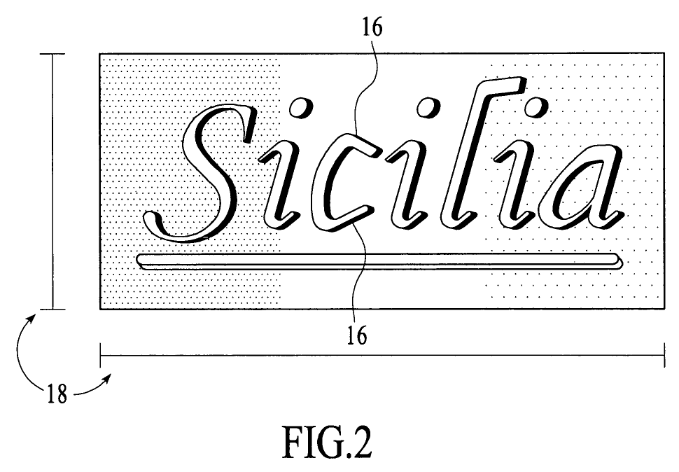

FIG. 2 shows an image applied onto the pre-stitched surface. The image can be composed of unlimited colors or gradients of shades; the image can also be a design of any type or composition. To transfer the digital image onto the pre-stitched surface, the preferred embodiment of this invention uses dye sublimation. Another example of a method of transfer is direct print, which is also included in the method as described herein and will be understood by those skilled in the art. Once the image is applied to the pre-stitched surface, the boundaries of the transferred image occasionally and randomly align 16 with the boundaries of the stitched patterns to create a visual effect of a design resembling traditional embroidery.

The pre-stitched surface with the image applied onto it is then attached to a final product. For example, final products onto which the illustrated embodiment of the present invention could be applied include a t-shirt, a baseball cap, a jacket, a backpack and other surfaces that will be apparent to those skilled in the art. Methods of attaching the pre-stitched surface containing the image onto the final product include sewing or using an adhesive such as fabric glue.

The method of the present invention includes first covering a patch of fabric or other surface with white, neutral-colored, or transparent thread using patterns of stitching that are random or abstract as to both alignment and shape, and then applying a digital image onto the pre-stitched fabric or surface. The pre-stitched surface can be shaped and sized as it will be later sewn or adhered to the final product such as a t-shirt, baseball hat, backpack or other surface. For example, the shape and size of the surface fabric chosen for illustration in FIG. 2 is a 2″×4¼″ rectangle 18, because the digital image requires a pre-stitched surface of those dimensions. Alternatively, if the pre-stitched surface is not pre-shaped and pre-sized as it will later be sewn or adhered onto the final product, after the image has been applied to the pre-stitched fabric, the fabric is then cut to a shape and size appropriate for the image.

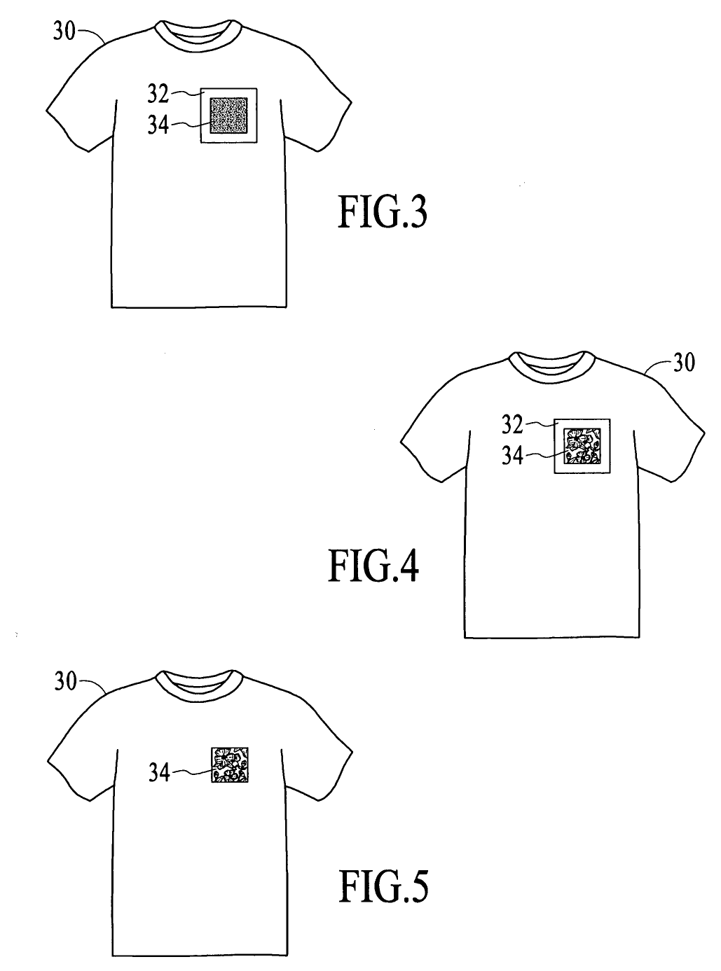

In another embodiment of this invention, the pre-stitched patterns are pre-stitched directly onto the final product in a pre-determined place and size, for example the front breast pocket of a T-shirt. The digital image is then applied with dye sublimation directly onto the pre-stitched pattern on the T-shirt. FIG. 3 illustrates pre-stitching a pattern directly onto a final product in a predetermined place and size. An article such as a t-shirt 30 has a pre-stitched pattern 34 applied directly to the article 30. It is preferred to use an embroidery backing/fabric stabilizer material 32 over which the stitching 34 is applied. In FIG. 3, the fabric stabilizer material 32 is applied in the appropriate location on the article, and then thread stitching is applied through the stabilizer material into the fabric. Thus, the part of the fabric stabilizer directly underneath the stitching area is attached to the fabric by the stitches.

When an image is applied to the pre-stitched area 34, as shown in FIG. 4 where a design is printed over the pre-stitched area, the fabric stabilizer material 32 serves as a border. If the printed image runs a bit from the printing or ink sublimation, the running is contained by the stabilizer material 32 and does not penetrate to article 30. With reference to FIG. 5, the fabric stabilizer material not attached to the article 30 (i.e the stabilizer material that is not between the article 30 and the stitching 34 on which the image is printed) can be removed. Removal can either be manual (such stabilizer materials are often “tear-away”) or by use of a cutter (such as a laser cutter) to detach the unsecured portions of the fabric stabilizer.

The process described herein converts photographs or artwork to an image that looks like embroidery. The image can then be printed in a limitless number of colors onto the pre-stitched surface, resulting in a final product that appears to be traditional stitched embroidery. The process is fast and inexpensive, and particularly suited to creation of individual or small lots of products with a chosen design. Thus, automated on-demand creation is possible for articles that appear to be embroidered.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A method for creating a stitched image resembling embroidery comprising the steps of:
(a) providing a piece of fabric with a stitching pattern having a uniform thread color, wherein the stitching pattern is random or abstract in alignment and shape;
(b) creating an image to be printed on the stitching pattern; and
(c) printing the image onto the stitching pattern.

2. The method of claim 1, wherein the image is printed using dye sublimation ink.

3. The method of claim 1, wherein before printing on the stitching the image is modified to resemble stitched embroidery.

4. The method of claim 1, wherein the thread color is selected from the group consisting of white thread, neutral colored thread, and transparent thread.

5. The method of claim 1, wherein the image is created using a digital image.

6. The method of claim 5, wherein the image is printed using dye sublimation ink.

7. The method of claim 5, wherein before printing on the stitching the image is modified to resemble stitched embroidery.

8. The method of claim 5, wherein the thread color is selected from the group consisting of white thread, neutral colored thread, and transparent thread.

9. The method of claim 1, wherein a fabric stabilizer material is placed over the fabric, whereby the stitching pattern connects the fabric stabilizer material to the fabric.

10. The method of claim 9, wherein the fabric stabilizer material prevents running of the printed image into the fabric.

11. The method of claim 9, wherein the image is printed using dye sublimation ink.

12. The method of claim 9, wherein before printing on the stitching the image is modified to resemble stitched embroidery.

13. The method of claim 9, wherein the thread color is selected from the group consisting of white thread, neutral colored thread, and transparent thread.

14. The method of claim 10, wherein the image is printed using dye sublimation ink.

15. The method of claim 10, wherein before printing on the stitching the image is modified to resemble stitched embroidery.

16. The method of claim 10, wherein the thread color is selected from the group consisting of white thread, neutral colored thread, and transparent thread.
